(19) United States
(12) Patent Application Publication
(10) Pub. No.: US 2020/0310071 A1
(43) Pub. Date: Oct. 1, 2020

(54) Optical Imaging System and Display Device with Optical Imaging System

(71) Applicant: ZHEJIANG SUNNY OPTICAL CO., LTD, Ningbo (CN)

(72) Inventors: Libang CHENG, Ningbo (CN); Li CHEN, Ningbo (CN); Fujian DAI, Ningbo (CN); Liefeng ZHAO, Ningbo (CN)

(21) Appl. No.: 16/817,628

(22) Filed: Mar. 13, 2020

(30) Foreign Application Priority Data
Mar. 26, 2019 (CN) 201910233390.X

(51) Int. Cl. G02B 7/02; G02B 13/00

(52) U.S. Cl. CPC G02B 7/021; G02B 13/001

(57) ABSTRACT

The disclosure provides an optical imaging system and a display device with the optical imaging system. The optical imaging system includes: at least one lens group, the at least one lens group including at least three lenses, the at least three lens elements being assembled in a buckling manner; and a lens barrel, used to bear the at least one lens group, wherein the at least three lenses sequentially include, from an object side to an image side along an optical axis, a first lens, a second lens and a third lens, the first lens is connected with the second lens in the buckling manner, the second lens is connected with the third lens in the buckling manner, and the third lens is combined and assembled with the lens barrel.

### CROSS-REFERENCE TO RELATED APPLICATION(S)

The present disclosure claims priority to Chinese Patent Application No. 201910233390.X, filed on Mar. 26, 2019 and entitled “Optical Imaging System and Display Device with Optical Imaging System”, the contents of which are hereby incorporated by reference in its entirety.

### TECHNICAL FIELD

The disclosure relates to a field of optics, and particularly to an optical imaging system and a display device with the optical imaging system.

### BACKGROUND

In recent years, along with rapid development of portable electronic products with a photographing function, requirements on miniature optical systems have also increased.

At present, an optical imaging lens of a capture device of a mobile phone mainly includes single parts such as a lens barrel, a plurality of lenses and a shading spacer, the plurality of lenses are sequentially assembled in the lens barrel from an object side to an image side, and the lens barrel wraps the lenses, resulting in severe limits to a size of a head of the optical imaging lens and unfavorability for design of a small head of the optical imaging lens. The lenses are sequentially stacked and assembled, and due to existence of forming errors, it is difficult to ensure coaxiality of the lenses, resulting in poor imaging quality of the optical imaging lens.

### SUMMARY

Some embodiments of the disclosure provides an optical imaging system and a display device with the optical imaging system, which solves the problems of difficulty in design of a small head structure and poor imaging quality of the optical imaging, system in a art known to inventors.

According to an embodiment of the disclosure, an optical imaging system is provided, which includes: at least one lens group, the at least one lens group including at least three lenses and the at least three lens elements being assembled in a buckling manner; and a lens barrel, used to bear the at least one lens group, wherein the at least three lenses sequentially includes, from an object side to an image side along an optical axis, a first lens, a second lens and a third lens, the first lens is connected with the second lens in the buckling manner, the second lens is connected with the third lens in the buckling manner, and the third lens is combined and assembled with the lens barrel.

In an exemplary embodiment, the first lens includes a first optical portion and a first protruding portion connected with the first optical portion, the second lens includes a second optical portion and a second protruding portion connected with the second optical portion, and the third lens is provided with a recess portion cooperated with both the first protruding portion and the second protruding portion.

In an exemplary embodiment, the recess portion has a first bearing surface and a second bearing surface connected with the first bearing surface, the first protruding portion contacts with the first bearing surface to connect the first lens and the third lens in the buckling manner, and the second protruding portion contacts with the second bearing surface to connect the second lens and the third lens in the buckling manner.

In an exemplary embodiment, the third lens includes a third optical portion and a third protruding portion connected with the third optical portion and extending to the object side, the third protruding portion and the third optical portion enclose the recess portion, and both the first bearing surface and the second bearing surface are positioned on the third protruding portion.

In an exemplary embodiment, a thickness of the third protruding portion is L4, and the thickness L4 satisfies a following relationship: L4≥0.25 mm.

In an exemplary embodiment, the first lens and the second lens bear each other, and a bearing length L1 satisfies a following relationship: 0.15 mm≤L1≤0.5 mm; and/or, the second lens and the third lens bear each other, and a bearing length L5 satisfies a following relationship: 0.15 mm≤L5≤0.5 mm.

In an exemplary embodiment, the first protruding portion has a first surface, and a contact length of the first surface and a first bearing surface of a recess portion of the third lens is L2; and the second protruding portion has a second surface, and a contact length of the second surface and a second bearing surface of the recess portion of the third lens is L3, lengths L2 and L3 satisfy following relationships:

0.07 mm≤L2≤0.2 mm and 0.07 mm≤L3≤0.2 mm.

In an exemplary embodiment, the optical imaging system further includes a first shading member, and the first shading member is positioned between the second lens and the third lens.

In an exemplary embodiment, an angle al of a demolding inclined plane of the first lens satisfies a following relationship: 20°≤a1≤45°; an angle a2 of a demolding inclined plane of the second lens satisfies a following relationship: 20°≤a2≤45°; and angles a3 and b1 of a demolding inclined plane of the third lens satisfy following relationships: 20°≤a3≤45° and 20°≤b1≤45°.

In an exemplary embodiment, the optical imaging system further includes a fourth lens and a fifth lens, and the fourth lens and the fifth lens are sequentially positioned on an image-side surface of the third lens element.

In an exemplary embodiment, the optical imaging system further includes: a second shading member, positioned between the third lens and the fourth lens; and a third shading member, positioned between the fourth lens and the fifth lens.

According to an embodiment of the disclosure, a display device is provided, which includes the abovementioned optical imaging system.

With adoption of the technical solutions of some embodiments of the disclosure, the at least three lenses are combined in the buckling manner, so that coaxiality of multiple lenses of the lens group is effectively ensured, and imaging quality of a lens is improved well.

### BRIEF DESCRIPTION OF THE DRAWINGS

The drawings forming a part of the application in the specification are adopted to provide a further understanding to the disclosure. Schematic embodiments of the disclosure and descriptions thereof are adopted to explain the disclosure and not intended to form improper limits to the disclosure. In the drawings:

FIG. 1 illustrates a structure diagram of an embodiment of an optical imaging system according to the disclosure;

FIG. 2A illustrates a partial structure diagram of FIG. 1;

FIG. 2B illustrates a partial structure diagram of FIG. 1;

FIG. 3 illustrates a partial enlarged drawing of FIG. 2A; and

FIG. 4 illustrates a partial structure diagram of FIG. 1.

### DETAILED DESCRIPTION OF THE EMBODIMENTS

It is to be noted that the embodiments in the application and characteristics in the embodiments may be combined without conflicts. The disclosure will be described below with reference to the drawings and in combination with the embodiments in detail.

In the disclosure and the embodiments of the disclosure, a surface, closest to an object, in each lens is called an object-side surface, and a surface, closest to an imaging surface, in each lens is called an image-side surface. That a first lens P1 and a second lens P2 bear each other refers to that the first lens P1 is in surface-to-surface contact with the second lens P2, and L1 refers to a contact length of the side, close to an imaging surface, of the first lens P1 and the side, close to an object, of the second lens P2. Similarly, that the second lens P2 and a third lens P3 bear each other refers to that the second lens P2 is in surface-to-surface contact with the third lens P3, and a bearing length L5 refers to a contact length of the side, far away from the object, of the second lens P2 and the side, close to the object, of the third lens P3.

In some embodiments of the disclosure, an optical portion (which may also be called an “effect diameter portion” or an “effective diameter portion”) is a portion with an optical function in a lens, and the optical portion may be provided to be concave or convex according to a specific requirement, as to diverge or converge light. A non-optical portion encloses and connects the optical portion and mainly acts to place and support the connected optical portion. In the embodiments of the disclosure, a first protruding portion P11, a second protruding portion P21 and a third protruding portion P31 are all non-optical portions.

In some embodiments of the disclosure, a non-effective diameter portion is relative to an effective diameter of the lens.

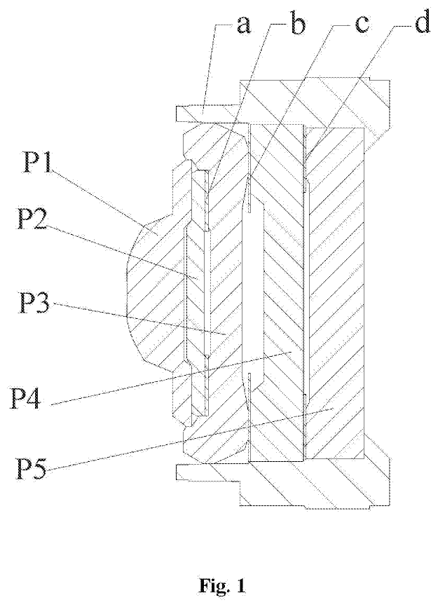

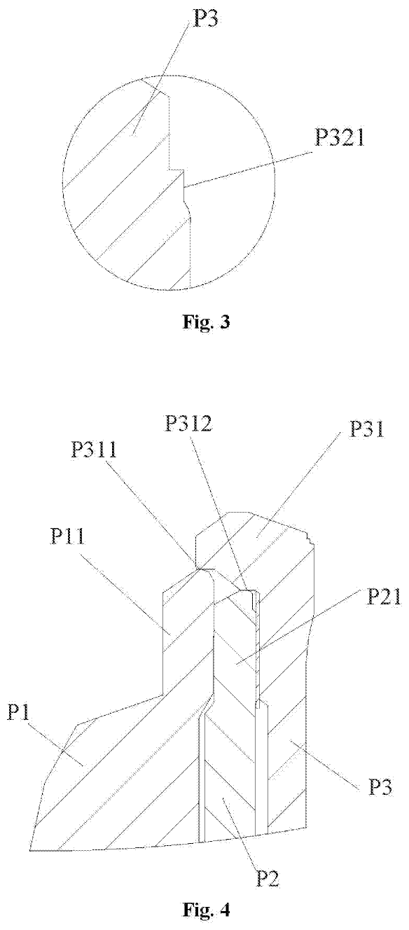

As shown in FIG. 1 to FIG. 3, an embodiment of the disclosure provides an optical imaging system. The optical imaging system of the embodiment includes a lens group and a lens barrel provided to bear the lens group, and the lens group includes three lenses.

In the art known to inventors, lenses are assembled in a sequential stacking manner, and due to existence of forming errors, it is difficult to ensure coaxiality of the lenses, resulting in poor imaging quality of an optical imaging lens. In some embodiments of the disclosure, the three lenses are assembled in a buckling manner, so that coaxiality of multiple lenses of the lens group is effectively ensured, and imaging quality of the optical imaging lens is improved well.

Of course, in an alternative embodiment not shown in the drawings of the disclosure, two or more (for example, three, four or six) lens groups may also be arranged according to a practical requirement to ensure the coaxiality of the multiple lenses and improve the imaging quality of the optical imaging lens better.

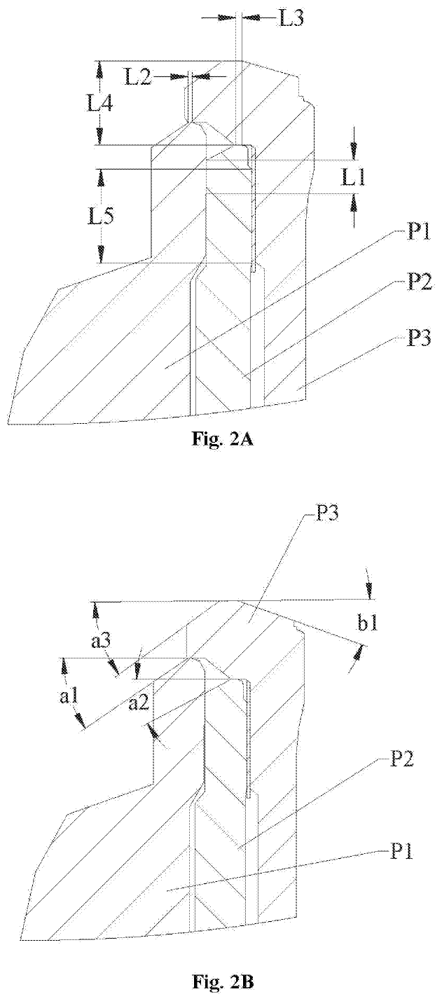

In some embodiments, as shown in FIG. 2A, the three lenses sequentially include, from an object side to an image side along an optical axis, a first lens P1, a second lens P2 and a third lens P3. The first lens P1 is connected with the third lens P3 in the buckling manner, and the second lens P2 is connected with the third lens P3 in the buckling manner.

In such an arrangement manner, the lens barrel a is an open structure, and then the third lens P3, the second lens P2 and the first lens P1 are sequentially assembled from the image side to the object side in an assembling process. In such an assembling manner, the first lens P1 is not required to be wrapped with the lens barrel a, so that a size of a head of the optical imaging lens is effectively reduced, and the optical imaging system meets a miniaturization requirement. Furthermore, the first lens P1 is connected with the third lens P3 in the buckling manner, and the second lens P2 is connected with the third lens P3 in the buckling manner, so that coaxiality of the plurality of lenses in the optical imaging lens is effectively ensured, and the imaging quality of the optical imaging lens is improved well.

In such an arrangement manner, when the lens group is required to be assembled together with the lens barrel a, an image-side lens group is sequentially assembled in the lens barrel a in a reverse assembling manner, and after the third lens P3 is fixed, the second lens P2 and the first lens P1 are sequentially cooperated with the third lens P3 to complete assembling of the optical imaging lens. In such a manner, a front end of the lens barrel a is not required to wrap the first lens P1, so that the size of the head of the optical imaging lens is reduced well, and a structural design of a small head is realized. In addition, since roundness of a middle of the lens barrel a is higher than roundness of an opening, the lens group is not easy to separate from the lens barrel a, and assembling accuracy is ensured.

Based on the above design concept, in the at least three lenses, the lens closest to the image side is taken as a buckling carrier, and a plurality of lenses on an object-side surface of the lens are all connected with the lens taken as the buckling carrier in the buckling manner. In an embodiment of the disclosure, the number of the lenses in the lens group is three. In some embodiments not shown in the drawings of the disclosure, the at least three lenses may also include more lenses, for example, six, sequentially including, from the image side to the object side, a sixth lens, a fifth lens, a fourth lens, the third lens, the second lens and the first lens, all the first to fifth lens are connected with the sixth lens in the buckling manner, respectively. In such case, when assembling is required, the sixth lens, the fifth lens, the fourth lens, the third lens, the second lens and the first lens are sequentially assembled from the image side to the object side in the reverse assembling manner. In such an assembling manner, the first lens P1 is not required to be wrapped with the lens barrel a, so that the size of the head of the optical imaging lens is effectively reduced, and the optical imaging system meets the miniaturization requirement. Furthermore, all the first to fifth lens are connected with the sixth lens in the buckling manner, so that the coaxiality of the plurality of lenses in the optical imaging lens is effectively ensured, and the imaging quality of the optical imaging lens is further improved well.

As shown in FIG. 1, in the embodiment of the disclosure, the third lens P3 is the buckling carrier, both the first lens P1 and the second lens P2 are buckled with the third lens P3, and a length of a non-effective diameter of the second lens P2 is less than a length of a non-effective diameter of the first lens P1.

Assembling the first lens P1, the second lens P2 and the third lens P3 in the buckling manner effectively ensures the coaxiality of the lenses, thereby improving the imaging quality of the optical imaging system well.

Of course, in the alternative embodiment not shown in the drawings of the embodiments of the disclosure, if the non-effective diameter allows, the first lens P1 is also connected with the second lens P2 in the buckling manner to form an integrated structure.

As shown in FIG. 1 and FIG. 4, in some embodiments of the disclosure, the first lens P1 includes a first optical portion and a first protruding portion P11 surrounding the first optical portion and connected with the first optical portion, the second lens P2 includes a second optical portion and a second protruding portion P21 surrounding the second optical portion, and the third lens P3 is provided with a recess portion cooperated with both the first protruding portion P11 and the second protruding portion P21.

As shown in FIG. 4, in some embodiments of the disclosure, the recess portion has a first bearing surface P311 and a second bearing surface P312 that are connected with each other. In some embodiments, both the first bearing surface P311 and the second bearing surface P312 are annular surfaces. The first protruding portion P11 contacts with the first bearing surface P311 of the third lens P3 to connect the first lens P1 and the third lens P3 in the buckling manner, and the second protruding portion P21 contacts with the second bearing surface P312 of the third lens P3 to connect the second lens P2 and the third lens P3 in the buckling manner.

In an embodiment of the disclosure, the recess portion is a stepped hole formed in the third lens P3, and the stepped hole includes a first straight hole section and a second straight hole section of which apertures sequentially decrease. An inner wall surface of the first straight hole section forms the first bearing surface P311, and an inner wall surface of the second straight hole section forms the second bearing surface P312. When the optical imaging lens is required to be assembled, the lenses are assembled from the image side to the object side in the reverse assembling manner, and after the third lens P3 is assembled in the lens barrel a, the second lens P2 and the first lens P1 are sequentially matched and assembled with the third lens P3 respectively.

As shown in FIG. 2A, in some embodiments of the disclosure, the stepped hole further includes a taper hole section used to communicate the first straight hole section with the second straight hole section, and an aperture of the taper hole section gradually decreases from the first straight hole section to the second straight hole section (namely from the object side to the image side). In such an arrangement manner, it is convenient to machining.

As shown in FIG. 2A and FIG. 4, in some embodiments of the disclosure, the third lens P3 includes a third optical portion and a third protruding portion P31. Wherein, the third protruding portion P31 is connected with the third optical portion and extending to the object side, and the third protruding portion P31 and the third optical portion enclose the recess portion.

A thickness of the third protruding portion P31 is L4, and the thickness L4 satisfies the following relationship: L4≥0.25 mm.

In some embodiments of the disclosure, as shown in FIG. 1, the optical imaging system further includes a first shading member b, and the first shading member b is positioned between the second lens P2 and the third lens P3.

In such an arrangement manner, by use of the first shading member b, a light path of a non-effective diameter portion of the lens is effectively blocked, and imaging stray light is reduced, so that the imaging quality is improved.

As shown in FIG. 1, in some embodiments, the optical imaging system further includes a fourth lens P4 and a fifth lens P5, and the fourth lens P4 and the fifth lens P5 are sequentially positioned on an image-side surface of the third lens P3.

As shown in FIG. 1, in some embodiments of the disclosure, the optical imaging system further includes a second shading member c and a third shading member d. The second shading member c is positioned between the third lens P3 and the fourth lens P4, and the third shading member d is positioned between the fourth lens P4 and the fifth lens P5.

In such an arrangement manner, by use of the second shading member c and the third shading member d, the light path of the non-effective diameter portion of the lens is effectively blocked, and the imaging stray light is reduced, so that the imaging quality is improved.

As shown in FIG. 2A, in some embodiments of the disclosure, after both the first lens P1 and the second lens P2 are buckled with the third lens P3, the first lens P1 and the second lens P2 bear each other, and a bearing length L1 satisfies the following relationship: 0.15 mm≤L1≤0.5 mm; and the second lens P2 and the third lens P3 bear each other, and a bearing length L5 satisfies the following relationship: 0.15 mm≤L5≤0.5 mm.

In such an arrangement manner, lengths of non-effective diameter portions of the three lenses are ensured, and the quality of each lens is improved, so that relatively high imaging quality of the optical imaging system is achieved, and the size of the head of the optical imaging lens is reduced.

In some embodiments of the disclosure, the first protruding portion P11 of the first lens P1 has a first surface, and a contact length of the first surface and the inner wall surface of the recess portion of the third lens P3 is L2; and the second protruding portion P21 of the second lens P2 has a second surface, and a contact length of the second surface and the recess portion of the third lens P3 is L3, the lengths L2 and L3 satisfy the following relationships:

0.07 mm≤L2≤0.2 mm; 0.07 mm≤L3≤0.2 mm.

In such an arrangement manner, it is ensured that both the first lens P1 and the second lens P2 are clamped in the recess portion of the third lens P3 and are not easy to separate from the third lens P3, so that the coaxiality of the lenses is effectively ensured when the first lens P1, the second lens P2 and the third lens P3 are assembled.

In an embodiment of the disclosure, the third lens P3 is demolded by use of an ejection structure. In some embodiments, an ejection structure P321 is provided on the side, far away from an object, of the third protruding portion of the third lens P3. Such an arrangement manner is favorable for forming a thick lens. In an embodiment, the ejection structure P321 is a stepped structure integrated with the third protruding portion.

As shown in FIG. 2B, in an embodiment of the disclosure, an angle al of a demolding inclined plane of the first lens P1 satisfies the following relationship: 20°≤a1≤45°. In such an arrangement manner, the first lens P1 is conveniently machined. For the same reason, an angle a2 of a demolding inclined plane of the second lens P2 also satisfies the following relationship: 20°≤a2≤45°, and angles a3 and b1 of a demolding inclined plane of the third lens P3 also satisfy the following relationships: 20°≤a3≤45° and 20°≤b1≤45°.

The technical solution of some embodiments of the disclosure will be described below in combination with FIG. 2A and FIG. 2B.

FIG. 2A shows a relationship of the three buckled lens elements. L1 represents that the first lens P1 and the second lens P2 bear each other, and L5 represents that the second lens P2 and the third lens P3 bear each other, the lengths L1 and L5 satisfy the relationship: 0.15 mm≤L1≤0.5 mm and 0.15 mm≤L5≤0.5 mm. L2 represents the contact length of the first surface of the first lens P1 and the third lens P3, and L3 represents the contact length of the second surface of the second lens P2 and the third lens P3, the lengths L2 and L3 satisfy the relationship: 0.07 mm≤L2≤0.2 mm and 0.07 mm≤L3≤0.2 mm. L4 represents a maximum thickness of a position bearing the non-effective diameter portion of the third lens P3, a magnitude of L4 satisfies a relationship L4≥0.25 mm.

Some embodiments of the disclosure also provides a display device, which includes the abovementioned optical imaging system. Therefore, the display device also has the abovementioned advantages of the optical imaging system. The optical imaging system may be applied to a mobile phone lens and, of course, may also be applied to a lens portion of another device such as a camera.

It can be seen from the above descriptions that the embodiments of the disclosure have the following technical effects. Three lens elements sequentially include, from the object side to the image side along the optical axis, the first lens P1, the second lens P2 and the third lens P3, the first lens P1 is buckled with the third lens P3, and the second lens P2 is buckled with the third lens P3. In such an arrangement manner, the lens barrel a is an open structure, and then the third lens P3, the second lens P2 and the first lens P1 are sequentially assembled from the image side to the object side. In such an assembling manner, the first lens P1 is not required to be wrapped with the lens barrel a, so that the size of the head of the lens portion is effectively reduced, and the optical imaging system satisfy the miniaturization requirement. Furthermore, the first lens P1 is connected with the third lens P3 in the buckling manner, and the second lens P2 is connected with the third lens P3 in the buckling manner, so that the coaxiality of the multiple lenses in the optical imaging lens is effectively ensured, and the imaging quality of the optical imaging lens is further improved well.

The above is only some embodiments of the disclosure and not intended to limit the disclosure. For those skilled in the art, the disclosure may have various modifications and variations. Any modifications, equivalent replacements, improvements and the like made within the spirit and principle of the disclosure shall fall within the scope of protection of the disclosure.

What is claimed is:

1. An optical imaging system, comprising:
at least one lens group, comprising at least three lenses, the at least three lenses being assembled in a buckling manner; and
a lens barrel, used to bear the at least one lens group, wherein
the at least three lenses sequentially comprise, from an object side to an image side along an optical axis,
a first lens,
a second lens, and
a third lens, the first lens is connected with the third lens in the buckling manner, the second lens is connected with the third lens in the buckling manner, and the third lens is combined and assembled with the lens barrel.

2. The optical imaging system as claimed in claim 1, wherein the first lens comprises a first optical portion and a first protruding portion connected with the first optical portion, the second lens comprises a second optical portion and a second protruding portion connected with the second optical portion, and the third lens is provided with a recess portion cooperated with both the first protruding portion and the second protruding portion.

3. The optical imaging system as claimed in claim 2, wherein the recess portion has a first bearing surface and a second bearing surface connected with the first bearing surface, the first protruding portion contacts with the first bearing surface to connect the first lens and the third lens in the buckling manner, and the second protruding portion contacts with the second bearing surface to connect the second lens and the third lens in the buckling manner.

4. The optical imaging system as claimed in claim 3, wherein the third lens comprises a third optical portion and a third protruding portion connected with the third optical portion and extending to the object side, the third protruding portion and the third optical portion enclose the recess portion, and both the first bearing surface and the second bearing surface are positioned on the third protruding portion.

5. The optical imaging system as claimed in claim 4, wherein a thickness of the third protruding portion is L4, and the thickness L4 satisfies a following relationship: L4≥0.25 mm.

6. The optical imaging system as claimed in claim 1, wherein the first lens and the second lens bear each other, and a bearing length L1 satisfies a following relationship: 0.15 mm≤L1≤0.5 mm; and, the second lens and the third lens bear each other, and a bearing length L5 satisfies a following relationship: 0.15 mm≤L5≤0.5 mm;
or, the first lens and the second lens bear each other, and a bearing length Ll satisfies a following relationship: 0.15 mm≤L1≤0.5 mm;
or, the second lens and the third lens bear each other, and a bearing length L5 satisfies a following relationship: 0.15 mm≤L5≤0.5 mm.

7. The optical imaging system as claimed in claim 2, wherein the first protruding portion has a first surface, and a contact length of the first surface and a first bearing surface of the recess portion of the third lens is L2; and the second protruding portion has a second surface, and a contact length of the second surface and a second bearing surface of the recess portion of the third lens is L3, the lengths L2 and L3 satisfy following relationships:
0.07 mm≤L2≤0.2 mm and 0.07 mm≤L3≤0.2 mm.

8. The optical imaging system as claimed in claim 1, further comprising a first shading member, wherein the first shading member is positioned between the second lens and the third lens element.

9. The optical imaging system as claimed in claim 1, wherein an angle al of a demolding inclined plane of the first lens satisfies a following relationship: 20°≤a1≤45°; an angle a2 of a demolding inclined plane of the second lens satisfies a following relationship: 20°≤a2≤45°; and angles a3 and b1 of a demolding inclined plane of the third lens satisfy following relationships:
20°≤a3≤45° and 20°23 b1≤45°.

10. The optical imaging system as claimed in claim 1, further comprising a fourth lens and a fifth lens, wherein the fourth lens and the fifth lens are sequentially positioned on an image-side surface of the third lens.

11. The optical imaging system as claimed in claim 10, further comprising:
a second shading member, positioned between the third lens and the fourth lens; and
a third shading member, positioned between the fourth lens and the fifth lens.

12. The optical imaging system as claimed in claim 2, wherein the first lens and the second lens bear each other, and a bearing length L1 satisfies a following relationship: 0.15 mm≤L1≤0.5 mm; and, the second lens and the third lens bear each other, and a bearing length L5 satisfies a following relationship: 0.15 mm≤L5≤0.5 mm;
or, the first lens and the second lens bear each other, and a bearing length L1 satisfies a following relationship: 0.15 mm≤L1≤0.5 mm;
or, the second lens and the third lens bear each other, and a bearing length L5 satisfies a following relationship: 0.15 mm≤L5≤0.5 mm.

13. The optical imaging system as claimed in claim 3, wherein the first lens and the second lens bear each other, and a bearing length L1 satisfies a following relationship: 0.15 mm≤L1≤0.5 mm; and, the second lens and the third lens bear each other, and a bearing length L5 satisfies a following relationship: 0.15 mm≤L5≤0.5 mm;
or, the first lens and the second lens bear each other, and a bearing length L1 satisfies a following relationship: 0.15 mm≤L1≤0.5 mm;
or, the second lens and the third lens bear each other, and a bearing length L5 satisfies a following relationship: 0.15 mm≤L5≤0.5 mm.

14. The optical imaging system as claimed in claim 4, wherein the first lens and the second lens bear each other, and a bearing length L1 satisfies a following relationship: 0.15 mm≤L1≤0.5 mm; and, the second lens and the third lens bear each other, and a bearing length L5 satisfies a following relationship: 0.15 mm≤L5≤0.5 mm;
or, the first lens and the second lens bear each other, and a bearing length L1 satisfies a following relationship: 0.15 mm≤L1≤0.5 mm;
or, the second lens and the third lens bear each other, and a bearing length L5 satisfies a following relationship: 0.15 mm≤L5≤0.5 mm.

15. The optical imaging system as claimed in claim 5, wherein the first lens and the second lens bear each other, and a bearing length L1 satisfies a following relationship: 0.15 mm≤L1≤0.5 mm; and, the second lens and the third lens bear each other, and a bearing length L5 satisfies a following relationship: 0.15 mm 0.5 mm;
or, the first lens and the second lens bear each other, and a bearing length L1 satisfies a following relationship: 0.15 mm≤L1≤0.5 mm;
or, the second lens and the third lens bear each other, and a bearing length L5 satisfies a following relationship: 0.15 mm≤L5≤0.5 mm.

16. The optical imaging system as claimed in claim 3, wherein the first protruding portion has a first surface, and a contact length of the first surface and the first bearing surface of the recess portion of the third lens is L2; and the second protruding portion has a second surface, and a contact length of the second surface and the second bearing surface of the recess portion of the third lens is L3, the lengths L2 and L3 satisfy following relationships:
0.07 mm≤L2≤0.2 mm and 0.07 mm≤L3≤0.2 mm.

17. The optical imaging system as claimed in claim 4, wherein the first protruding portion has a first surface, and a contact length of the first surface and the first bearing surface of the recess portion of the third lens is L2; and the second protruding portion has a second surface, and a contact length of the second surface and the second bearing surface of the recess portion of the third lens is L3, the lengths L2 and L3 satisfy following relationships:
0.07 mm≤L2≤0.2 mm and 0.07 mm≤L3≤0.2 mm.

18. The optical imaging system as claimed in claim 5, wherein the first protruding portion has a first surface, and a contact length of the first surface and the first bearing surface of the recess portion of the third lens is L2; and the second protruding portion has a second surface, and a contact length of the second surface and the second bearing surface of the recess portion of the third lens is L3, the lengths L2 and L3 satisfy following relationships:
0.07 mm≤L2≤0.2 mm and 0.07 mm≤L3≤0.2 mm.

19. The optical imaging system as claimed in claim 2, further comprising a first shading member, wherein the first shading member is positioned between the second lens and the third lens element.

20. A display device, comprising the optical imaging system as claimed in claim 1.
